(19) United States
(12) Patent Application Publication
(10) Pub. No.: US 2011/0217556 A1
(43) Pub. Date: Sep. 8, 2011

(54) OPTICAL COMPONENT AND MANUFACTURING METHOD THEREOF

(75) Inventors: TAKESHI DEGUCHI, Tokyo (JP); Yoshito Ito, Tokyo (JP); Kei Kikuchi, Tokyo (JP); Nobuyoshi Toyohara, Sagamihara-shi (JP)

(73) Assignee: Olympus Corporation, Tokyo (JP)

(21) Appl. No.: 13/038,721

(22) Filed: Mar. 2, 2011

(30) Foreign Application Priority Data
Mar. 8, 2010 (JP) 2010-050607

(51) Int. Cl. B32B 27/36; B32B 27/32; B32B 27/30; B05D 5/06

(52) U.S. Cl. 428/412; 428/523; 428/500; 427/162; 427/569; 427/457

(57) ABSTRACT

An optical component that includes a substrate and an optical thin film formed on the substrate. An internal stress σ (in units of MPa) satisfies Expression (1) given below when x=|E/R| is in the range of 0 to 3:

σ≦−30x (1),

where E is an effective optical diameter (in units of mm) of the substrate, R is a radius of curvature (in units of mm) of the substrate, and x is an absolute value of a ratio of E to R.

The present application is based upon and claims the benefit of priority from the prior Japanese Patent Application No. 2010-050607 filed on Mar. 8, 2010; the entire contents of which are incorporated herein by reference.

### BACKGROUND OF THE INVENTION

1. Field of the Invention

The present invention relates to an optical component and a manufacturing method thereof.

2. Description of the Related Art

Substrates made of resin have been used more commonly in recent years to manufacture optical systems inexpensively and in large quantities. Furthermore, there is a tendency towards making a ratio x of an effective optical diameter E to a radius of curvature R of the substrate larger to make the optical system more compact and smaller.

Optical systems that are typically used in digital cameras or vehicle mounted cameras are used in a wide range of environments, and are therefore required to be more durable against variation in environmental conditions such as temperature and humidity.

An antireflective film needs to be provided on a surface of a resin substrate to improve a transmittance of light and to prevent unnecessary reflection of light within the optical system. However, compared to an antireflective film formed on a glass substrate, the antireflective film formed on the resin substrate has a lower durability and tends to appear shabby because of chapping, cracking, peeling, wrinkling, etc., due to the variation in the environmental conditions such as temperature and humidity. This problem is particularly notable in the antireflective film formed on a substrate that has a larger ratio x of the effective optical diameter E to the radius of curvature R.

An optical element is proposed in Japanese Patent Application Laid-open No. 2004-271653 with a view to providing a solution to the above-described problem. The optical element is designed such that all the stress that is produced in a multilayer film formed on a shaped resin surface is compressive stress. A durability of the multilayer film formed on the resin surface is particularly improved by limiting the compressive stress to 120 Pa·m or less.

### SUMMARY OF THE INVENTION

An optical component according to the present invention includes an optical thin film formed on a substrate such that an internal stress σ (in units of megapascal (MPa)) satisfies Expression (1) given below when x=|E/R| is in the range of 0 to 3.

σ≦−30x (1)

where E is an effective optical diameter (in units of millimeter (mm)) of the substrate, R is a radius of curvature (in units of mm) of the substrate, and x is an absolute value of a ratio of E to R.

A method of manufacturing an optical component according to the present invention includes forming the optical thin film on the substrate such that the internal stress σ (MPa) satisfies Expression (1) given below when x=|E/R| is in the range of 0 to 3.

σ≦−30x (1)

where E is the effective optical diameter of the substrate (mm), R is the radius of curvature of the substrate (mm), and x is the absolute value of the ratio of E to R.

### BRIEF DESCRIPTION OF THE DRAWINGS

FIG. 1 is a side view depicting an exemplary structure of an optical component according to an embodiment of the present invention;

FIG. 2 is a graph depicting a relation between an applied power (in units of Watts (W)) to a plasma gun and an internal stress σ (in units of MPa) during SiO₂ film deposition;

FIG. 3 is a graph depicting a relation between the applied power (in units of W) to the plasma gun and the internal stress σ (in units of MPa) during TiO₂ film deposition;

FIG. 4 is a graph depicting a relation between the applied power (in units of W) to the plasma gun and the internal stress σ (in units of MPa) during MgF₂ film deposition;

FIG. 5 is a graph depicting a relation between the applied power (in units of W) to the plasma gun and the internal stress σ (in units of MPa) during Ta₂O₅ film deposition; and

FIG. 6 is a graph depicting a relation between |E/R| and an initial value of the internal stress σ (in units of MPa) immediately after film formation.

### DETAILED DESCRIPTION OF THE INVENTION

Exemplary embodiments of an optical component and a manufacturing method thereof according to the present invention are explained below in detail with reference to the accompanying drawings. The present invention is not limited to the embodiments described below.

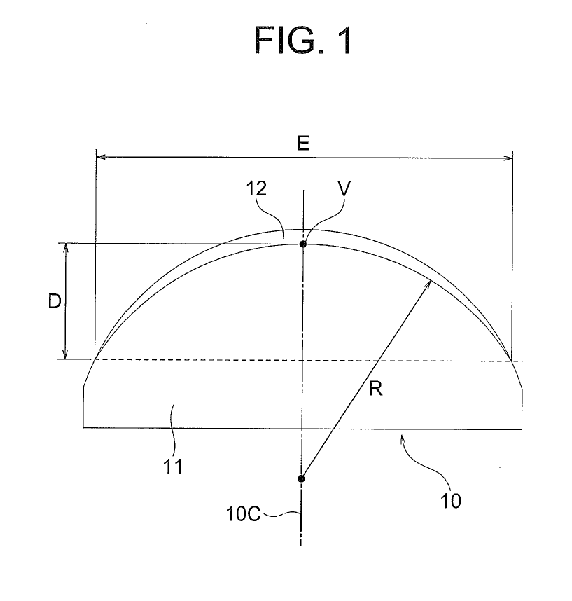

FIG. 1 is a side view depicting an exemplary structure of the optical component according to an embodiment of the present invention.

An optical component 10 according to the present embodiment includes an optical thin film 12 (for example, antireflective film) formed on a resin substrate 11. If an effective optical diameter of the substrate 11 is E (in units of mm) and a radius of curvature of the substrate 11 is R (mm), an internal stress σ (in units of MPa) satisfies Expression (1) given below when an absolute value x=|E/R| of a ratio of E to R is in the range of 0 to 3. A positive internal stress σ indicates a tensile strength and a negative internal stress σ indicates a compressive stress.

σ≦−30x (1)

Ideally, instead of the conditional expression (1), the following conditional expression (1′) should preferably be satisfied.

σ≦−50x (1′)

As shown in FIG. 1, a film thickness of the optical thin film 12 should be ideally thicker as one goes toward a surface peak V. However, a film thickness range can be set appropriately according to the type of the optical thin film 12 and the usage thereof.

The paraxial radius of curvature is included in the radius of curvature R.

The internal stress σ also satisfies Expression (2) given below.

−30x−300≦σ≦−30x (2)

More ideally, instead of the conditional expression (2), the following conditional expression (2′) should preferably be satisfied.

−50x−250≦σ≦−50x (2′)

The optical thin film 12 may be formed on one surface or on both the surfaces of the substrate 11 according to the specifications of the optical component 10. The optical thin film 12 should preferably be formed by stacking a plurality of films, and at least one of the layers should be formed by an ion assisted deposition method or a plasma assisted deposition method. In the ion assisted deposition method or the plasma assisted deposition method, parameters of the ion assisted deposition method or the plasma assisted deposition method are controlled according to a constituent material of the layer being formed.

### EXAMPLES

Examples of the present embodiment are explained below.

Three substrates L1, L2, and L3 shown in Table 1 are used as resin substrates.

TABLE 1

| Name | Material | Surface | E | D | R | \|E/R\| | \|D/R\| |
|---|---|---|---|---|---|---|---|
| L1 | Cycloolefin | L11 | 6.5 | 0.10 | 200.2 | 0.03 | 0.00 |
| | series resin | L12 | 4.2 | 1.55 | 2.2 | 1.93 | 0.70 |
| L2 | Acrylic | L21 | 4.3 | 1.14 | 4.4 | 0.99 | 0.26 |
| | series resin | L22 | 3.0 | −0.012 | −8.1 | 0.37 | 0.00 |
| L3 | Polycarbonate | L31 | 2.2 | 0.04 | 10.0 | 0.22 | 0.00 |
| | series resin | L32 | 3.0 | −0.62 | −1.8 | 1.67 | 0.34 |

In Table 1, E is the effective optical diameter (mm), D is a lens depth (mm), and R is the paraxial radius of curvature (mm). |E/R| is the absolute value of the ratio of the effective optical diameter E to the paraxial radius of curvature R, and |D/R| is an absolute value of a ratio of the lens depth D to the paraxial radius of curvature R. The lens depth D is a thickness of a part of a lens corresponding to the effective optical diameter E.

As shown in Table 1, the substrate L1 is made of a resin of cycloolefin series, the substrate L2 is made of resin of acrylic series, and the substrate L3 is made of a resin of polycarbonate series. The shape and the material of the substrate are not limited to these, and the substrate L1 and L2, for example, can be made of a resin of polycarbonate series.

Surfaces L11 and L12 of the substrate L1 are opposing faces, surfaces L21 and L22 of the substrate L2 are opposing faces, and surfaces L31 and L32 of the substrate L3 are opposing faces.

A constant temperature and humidity test and a thermal shock test were performed as environment tests. The conditions for environment tests are given below.

(1) Conditions for the constant temperature and humidity test: Exposure to a temperature of 85° C. and humidity of 40% for 1000 hours.

(2) Conditions for the thermal shock test: alternating exposure to temperatures of −40° C. and +85° C. for 30 minutes each, the total 1 hour was repeated for 1000 cycles.

Evaluation of the external appearance after the environment tests was carried out. That is, presence or absence of cracks, wrinkles, chapping, and peeling of the thin film formed on the surface of the resin substrate was visually confirmed by viewing the resin substrate under a stereoscopic microscope made by Olympus Corporation while illuminating the resin substrate obliquely.

As a method for measuring the internal stress, a disc method was used.

The internal stress σ is determined by Expression (3) given below:

σ=Esb²/[6(1−Vs)rd] (3)

where Es is Young's modulus, Vs is Poisson's ratio, b is a thickness of the substrate, d is a thickness of the optical thin film, and r is the radius of curvature of the substrate.

Specifically, a silicon wafer having a diameter of 4 inches and the thickness b of 525 micrometers (μm) is set in a chamber with the substrate, and the optical thin film is formed on the silicon wafer (on the mirror surface side). A deformation amount of the silicon wafer substrate was measured immediately after film formation.

To measure the thickness of the optical thin film, the following method was adopted. A straight line was drawn with a permanent marker on a glass flat plate. The silicon wafer and the glass flat plate were simultaneously set inside the chamber, and film was deposited. After the film was deposited, the part marked by the permanent marker was removed with ethanol to create a level difference. The level difference was measured and the value obtained was regarded as the film thickness.

Concrete examples and comparative examples are explained below in detail.

### Concrete Example 1

An antireflective film that serves as an optical thin film of several layers of a low refractive index material SiO₂, and a high refractive index material Ta₂O₅ was deposited on both the surfaces of the resin substrate. The antireflective film has a four-layer structure with alternating Ta₂O₅ and SiO₂ layers, the first layer on the substrate side being that of Ta₂O₅.

A plasma gun was used to perform plasma irradiation during the deposition of the SiO₂ and Ta₂O₅ layers of the antireflective film using the plasma assisted deposition method.

The ion assisted deposition method can be used in place of the plasma assisted deposition method. In the ion assisted deposition method or the plasma assisted deposition method, the parameters (for example, gas flow amount, irradiation duration, and applied power) should preferably be controlled according to a constituent material of the layer being formed.

The low refractive index material SiO₂ can be of any shape. It can be granular, sintered pellet or molten ring. A mixture with Al₂O₃ can also be used as long as the main component is SiO₂.

TiO₂ or Nb₂O₅ can be used in place of Ta₂O₅ as a high refractive index material. Similar to the low refractive index material, the high refractive index material also can be of any shape.

### Concrete Example 2

An antireflective film that serves as an optical thin film of several layers of a low refractive index material SiO₂, and a high refractive index material TiO₂ was deposited on both the surfaces of the resin substrate. The antireflective film has a five-layer structure with alternating TiO₂ and SiO₂ layers, the first layer on the substrate side being that of TiO₂.

A plasma gun was used to perform plasma irradiation during the deposition of the SiO₂ layer of the antireflective film using the plasma assisted deposition method.

The ion assisted deposition method can be used in place of the plasma assisted deposition method. In the ion assisted deposition method or the plasma assisted deposition method, the parameters (for example, gas flow amount, irradiation duration, and applied power) should preferably be controlled according to a constituent material of the layer being formed.

The low refractive index material SiO₂ can be of any shape. It can be granular, sintered pellet or molten ring. A mixture with Al₂O₃ can also be used as long as the main component is SiO₂.

Ta₂O₅ or Nb₂O₅ can be used in place of TiO₂ as a high refractive index material. Similar to the low refractive index material, the high refractive index material also can be of any shape. A mixture with La can also be used as long as the main component is TiO₂.

### Concrete Example 3

An antireflective film that serves as an optical thin film of several layers of a low refractive index material SiO₂, a high refractive index material TiO₂, and a topmost layer of MgF₂ was deposited on both the surfaces of the resin substrate. The antireflective film has a seven-layer structure with alternating SiO₂ and TiO₂ layers, the first layer on the substrate side being that of SiO₂ and the topmost layer being that of MgF₂.

A plasma gun was used to perform plasma irradiation during the deposition of the SiO₂ layer of the antireflective film using the plasma assisted deposition method.

The ion assisted deposition method can be used in place of the plasma assisted deposition method. In the ion assisted deposition method or the plasma assisted deposition method, the parameters (for example, gas flow amount, irradiation duration, and applied power) should preferably be controlled according to a constituent material of the layer being formed.

The low refractive index material SiO₂ can be of any shape. It can be granular, sintered pellet or molten ring. A mixture with Al₂O₃ can also be used as long as the main component is SiO₂. The material of MgF₂ can also be of any shape.

Ta₂O₅ or Nb₂O₅ can be used in place of TiO₂ as a high refractive index material. Similar to the low refractive index material, the high refractive index material also can be of any shape. A mixture with La can also be used as long as the main component is TiO₂.

### Comparative Example 1

The structure of the film in the Comparative Example 1 is similar to that of Concrete Example 1. However, a vapor deposition method was used instead of the plasma assisted deposition method. The value of the internal stress σ was 20 MPa.

### Comparative Example 2

A structure of the film in the Comparative Example 2 is similar to that of Concrete Example 2. However, the vapor deposition method was used instead of the plasma assisted deposition method. The value of internal stress σ was 20 MPa.

### Comparative Example 3

A structure of the film in the Comparative Example 3 is similar to that of Concrete Example 3. However, the vapor deposition method was used instead of the plasma assisted deposition method. The value of internal stress σ was 30 MPa.

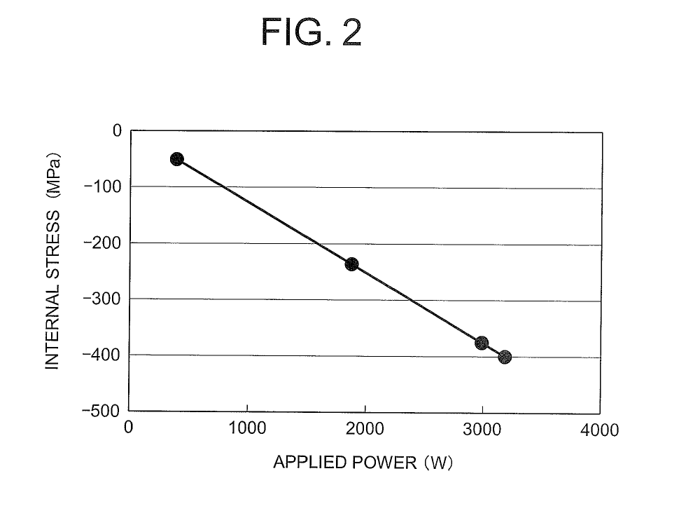

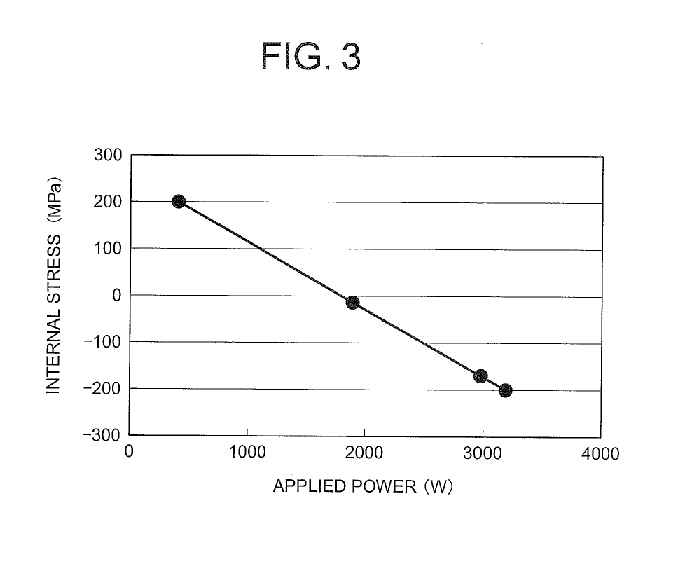

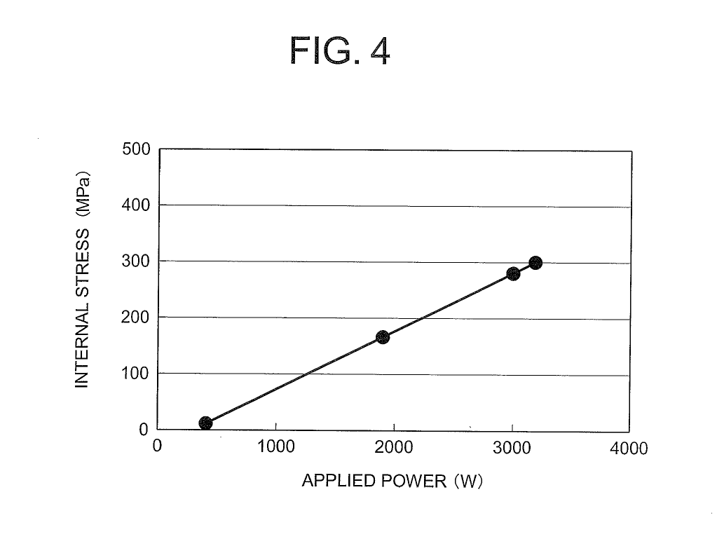

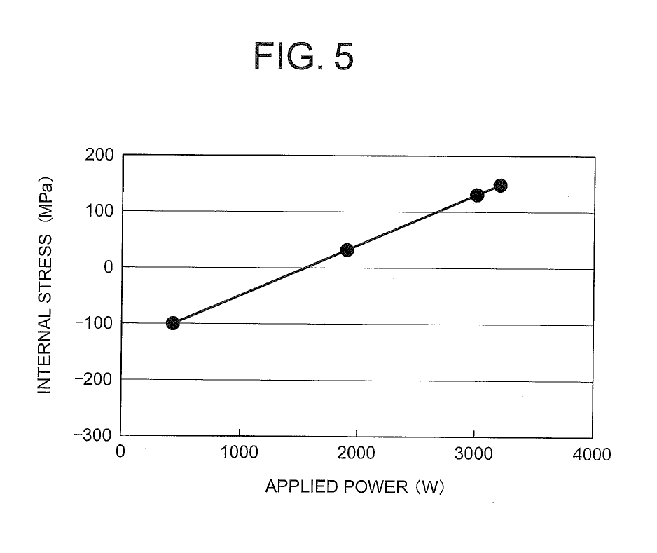

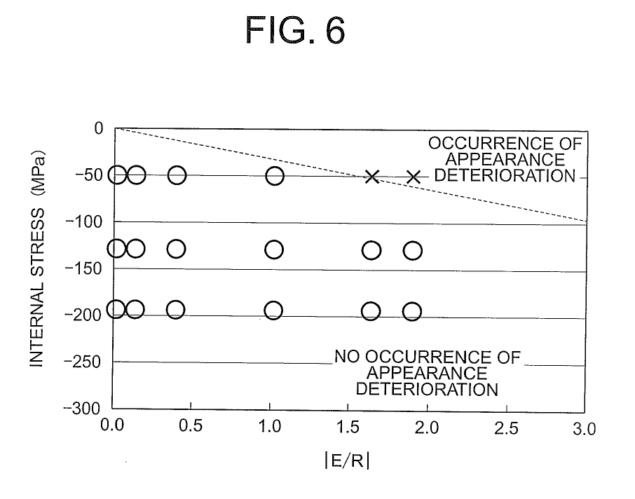

FIG. 2 is a graph depicting a relation between the applied power (in units of Watts (W)) to the plasma gun and the internal stress σ (in units of MPa) during the SiO₂ film deposition. FIG. 3 is a graph depicting a relation between the applied power (in units of W) to the plasma gun and the internal stress σ (in units of MPa) during the TiO₂ film deposition. FIG. 4 is a graph depicting a relation between the applied power (in units of W) to the plasma gun and the internal stress σ (in units of MPa) during the MgF₂ film deposition. FIG. 5 is a graph depicting a relation between the applied power (in units of W) to the plasma gun and the internal stress σ (in units of MPa) during the Ta₂O₅ film deposition. FIG. 6 is a graph depicting a relation between |E/R| and an initial value of the internal stress σ (in units of MPa) immediately after film formation. The applied power to the plasma gun is calculated by multiplying a discharge voltage (in units of Volts (V)) with a discharge current value (in units of Amperes (A)).

As can be surmised from FIGS. 2 to 5, absolute values of the power applied to the plasma gun and the internal stress σ show a proportional relation. It can be understood that the durability of the optical thin film improves by applying the plasma assisted deposition method in which the internal stress σ of the optical thin film is appropriately set so that it is within the scope of the claims.

In FIG. 6, hollow circles indicate that a deterioration of appearance has occurred, and crosses indicate that the deterioration of appearance has not occurred after environment test. Furthermore, the data that are arranged horizontally at the same value of the internal stress σ correspond to each surface of the three types of substrates shown in Table 1. In FIG. 6, three values of the internal stress σ have been shown only as an example; the optical thin films in all the concrete examples can be formed to have three values of the internal stress σ.

The deterioration of appearance occurs in instances that are above and to the right of the dashed line in FIG. 6; and the deterioration of appearance does not occur in instances that are below and to the lower left of the dashed line in FIG. 6. That is, it can be deduced that when the absolute values of |E/R| and the internal stress σ exceed a certain value, there is a tendency for deterioration of appearance to occur.

Furthermore, in the comparative examples, cracks had already started appearing after lapse of 250 hours in the environment test. On the contrary, in the concrete examples, in the instances where the deterioration of appearance did not occur, a chronological change of the internal stress σ after 1000 hours from the start of the environment test was within 100 MPa compared to the initial value.

Thus, as described above, the present invention provides an optical component that includes an optical thin film deposited on a resin substrate, and that has an improved durability against the variations in the environmental conditions such as temperature and humidity.

An optical component and a manufacturing method thereof according to the present invention has an effect of improving a durability of an optical thin film formed on a resin substrate against variations in environmental conditions such as temperature and humidity.

What is claimed is:

1. An optical component including a substrate and an optical thin film formed on the substrate,
wherein an internal stress σ, in units of MPa, satisfies Expression (1) given below when x=|E/R| is in the range of 0 to 3:
σ≦−30x (1),
where E, in units of mm, is an effective optical diameter of the substrate, R, in units of mm, is a radius of curvature of the substrate, and x is an absolute value of a ratio of E to R.

2. The optical component according to claim 1, wherein the internal stress σ satisfies Expression (2) given below:
−30x−300≦σ≦−30x (2).

3. The optical component according to claim 1, wherein the optical thin film is formed on both sides of the substrate.

4. The optical component according to claim 1, wherein the substrate is made of resin.

5. The optical component according to claim 1, wherein at least one layer of the optical thin film is formed by an ion assisted deposition method or a plasma assisted deposition method.

6. The optical component according to claim 5, wherein parameters of the ion assisted deposition method or the plasma assisted deposition method are controlled according to a constituent material of the layer formed by the ion assisted deposition method or the plasma assisted deposition method.

7. A method of manufacturing an optical component comprising:
forming an optical thin film on a substrate,
wherein an internal stress σ, in units of MPa, satisfies Expression (1) given below when x=|E/R| is in the range of 0 to 3:
σ≦−30x (1),
where E, in units of mm, is an effective optical diameter of the substrate, R, in units of mm, is a radius of curvature of the substrate, and x is an absolute value of a ratio of E to R.

8. The optical component manufacturing method according to claim 7, wherein the internal stress σ satisfies Expression (2) given below:
−30x−300≦σ≦−30x (2).

9. The optical component manufacturing method according to claim 7, wherein the optical thin film is formed on both sides of the substrate.

10. The optical component manufacturing method according to claim 7, wherein the substrate is made of resin.

11. The optical component manufacturing method according to claim 7, wherein at least one layer of the optical thin film is formed by an ion assisted deposition method or a plasma assisted deposition method.

12. The optical component manufacturing method according to claim 11, wherein parameters of the ion assisted deposition method or the plasma assisted deposition method are controlled according to a constituent material of the layer formed by the ion assisted deposition method or the plasma assisted deposition method.
